(19) United States
(12) Patent Application Publication
(10) Pub. No.: US 2024/0372151 A1
(43) Pub. Date: Nov. 7, 2024

(54) MOLECULAR SOLID ELECTROLYTE AND LITHIUM METAL BATTERY CONTAINING THE SAME

(71) Applicant: UNIST(ULSAN NATIONAL INSTITUTE OF SCIENCE AND TECHNOLOGY), Ulsan (KR)

(72) Inventors: Hyun-Kon SONG, Ulsan (KR); Dosol CHEONG, Ulsan (KR)

(21) Appl. No.: 18/654,164

(22) Filed: May 3, 2024

(30) Foreign Application Priority Data
May 4, 2023 (KR) 10-2023-0058753
Apr. 11, 2024 (KR) 10-2024-0048825

(51) Int. Cl. H01M 10/0569; H01M 4/02; H01M 4/40; H01M 4/58; H01M 10/0525; H01M 10/0567

(52) U.S. Cl. CPC H01M 10/0569; H01M 4/405; H01M 4/5825; H01M 10/0525; H01M 10/0567; H01M 2004/027; H01M 2004/028; H01M 2300/004; H01M 2300/0085

(57) ABSTRACT

Disclosed are a molecular solid electrolyte and a lithium metal battery including the same, the molecular solid electrolyte formed from an electrolyte solution including a non-aqueous organic solvent, and a lithium salt,
wherein the non-aqueous organic solvent is a single solvent, in the molecule, at least one central atom selected from a carbon atom, a nitrogen atom, a sulfur atom, and an atomic group consisting of these is contained, each of the central atoms are each independently linked to at least one oxygen atom; at least one sulfur atom; or a maximum distance between two adjacent negatively charged atoms among the oxygen atom, sulfur atom, and nitrogen atom located at or linked to the central atom is less than or equal to about 5 Å, and
the electrolyte solution undergoes a phase change to a solid below a freezing point of the electrolyte solution to form a lattice structure including a lithium transfer channel.

### CROSS-REFERENCE TO RELATED APPLICATION

This application claims priority to and the benefit of Korean Patent Application No. 10-2023-0058753 filed in the Korean Intellectual Property Office on May 4, 2023 and Korean Patent Application No. 10-2024-0048825 filed in the Korean Intellectual Property Office on Apr. 11, 2024, the entire contents of which are incorporated herein by reference.

### BACKGROUND OF THE INVENTION

### (a) Field of the Invention

This disclosure relates to a molecular solid electrolyte and a lithium metal battery including the same, and more specifically, to a molecular solid electrolyte that can be operated at temperatures below a freezing point of the electrolyte and can suppress formation of lithium dendrites in the lithium metal negative electrode, and a lithium metal battery including the same.

### (b) Description of the Related Art

Since commercially available in 1991, lithium ion batteries have played a very important role in the rapid development of portable electronic devices including mobile phones and laptop computers and the recent emergence of electric vehicles.

However, the lithium ion batteries, even though stable by using a intercalation-based electrode material, have significant limitations on capacity of electrodes, and recently, as the demand for batteries with much higher energy density has rapidly grown, the development of new batteries with higher energy density than currently available lithium ion batteries has become urgent.

Accordingly, lithium metal batteries using lithium metal as a negative electrode are drawing attentions. The currently commercialized lithium ion batteries use a graphite material with theoretical capacity of about 372 mAh/g as a negative electrode, but the lithium metal has theoretical capacity of about 3,860 mAh/g, which is about 10 times or more higher than the graphite, the lowest electrochemical potential of about-3.040 V, compared with that of a standard hydrogen electrode (SHE), and low density of about 0.534 g/cm³, which shows great potential as a negative electrode.

In order for lithium metal negative electrode is used, however, the lithium metal negative electrode still has a major challenge of securing stability due to an internal short circuit of batteries by formation of dendrite on the surface and a problem of overcoming low coulombic efficiency.

### SUMMARY OF THE INVENTION

An embodiment provides a molecular solid electrolyte that can be driven by forming a lithium transfer channel by changing a phase to a solid even at a temperature below a freezing point of the electrolyte and can suppress the formation of lithium dendrites in a lithium metal negative electrode, and a lithium metal battery including the same.

In an embodiment of the present invention, a molecular solid electrolyte formed from an electrolyte solution including a non-aqueous organic solvent, and a lithium salt,
wherein the non-aqueous organic solvent is a single solvent, in the molecule, at least one central atom selected from a carbon atom, a nitrogen atom, a sulfur atom, and an atomic group consisting of these is contained, each of the central atoms are each independently linked to at least one oxygen atom; at least one sulfur atom; or at least one nitrogen atom, a maximum distance between two adjacent negatively charged atoms among the oxygen atom, sulfur atom, and nitrogen atom located at or linked to the central atom is less than or equal to about 5 Å, and
the electrolyte solution undergoes a phase change to a solid below a freezing point of the electrolyte solution to form a lattice structure including a lithium transfer channel.

The non-aqueous organic solvent may be a compound including at least one of an acid anhydride functional group, an ester group, an amide group, a nitrile group, a nitrate group, a nitrite group, a nitro group, an imide group, an azide group, a sulfone group, a sulfonate group, a thiocyanate group, an isothiocyanate group, a carbonate group, a lactone group, a ketone group, and a thiol group.

The non-aqueous organic solvent may include an acid anhydride compound, an ester compound, an amide compound, a nitrate compound, a nitrite compound, a nitro compound, an imide compound, an azide compound, a sulfone compound, a sulfonate ester compound, a thiocyanate compound, an isothiocyanate compound, a carbonate compound, a lactone compound, a compound including at least two nitrile groups, a compound including at least two ketone groups, or a compound including at least two thiol groups.

The non-aqueous organic solvent may be at least one of a sulfone compound, a carbonate compound, and a compound including at least two nitrile groups.

The sulfone compound may be a cyclic sulfone compound and may be represented by Chemical Formula 1, the carbonate compound may be a cyclic carbonate compound or a linear carbonate compound and may be represented by Chemical Formula 2 or Chemical Formula 3, and the compound including at least two nitrile groups may be a linear nitrile compound and may be represented by Chemical Formula 4.

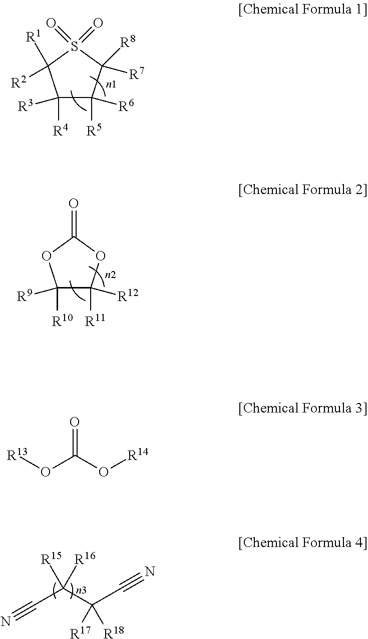

In Chemical Formula 1 to Chemical Formula 4,
R¹ to R¹⁴ are each independently hydrogen, a halogen, a substituted or unsubstituted C1 to C10 alkyl group, a substituted or unsubstituted C2 to C10 alkenyl group, or a substituted or unsubstituted C6 to C20 aryl group,
R¹⁵ to R¹⁸ are each independently hydrogen, a halogen, a cyano group, a substituted or unsubstituted C1 to C10 alkyl group, a substituted or unsubstituted C2 to C10 alkenyl group, or a substituted or unsubstituted C6 to C20 aryl group,
n1 and n2 are each independently an integer of 1 or 2, and
n3 is one of integers of 1 to 5.

The non-aqueous organic solvent may have a packing coefficient represented by Equation 1 of about 1 to about 1.1.

Packing coefficient=(Density in solid phase)/(Density in liquid phase). <Equation 1>

The molecular solid electrolyte may have ionic conductivity of greater than or equal to about 1.0×10⁻³ mS·cm⁻¹, and the lithium ion transference number (Li⁺ transference number) may be about 0.6 to about 1.0.

The lithium salt may be at least one of LiPF₆, LiBF₄, LiSbF₆, LiAsF₆, LiC₄F₉SO₃, LiClO₄, LiAlO₂, LiAlCl₄, LiCl, LiI, LiB(C₂O₄)₂ (lithium bis(oxalato) borate; LiBOB), LiDFOB (lithium difluoro (oxalato) borate), and a bissulfonyl imide-based lithium salt.

The bissulfonyl imide-based lithium salt may be Li(FSO₂)₂N or LIN (CₓF₂ₓ₊₁SO₂) (C_{y}F_{2y+1}SO₂) (wherein x and y are integers from 1 to 20).

For example, the bissulfonyl imide-based lithium salt may be represented by any one of Chemical Formula 5A to Chemical Formula 5D.

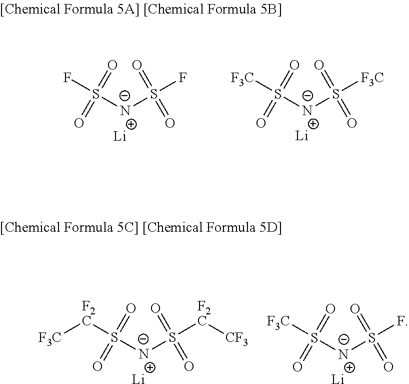

Another embodiment of the present invention provides a lithium metal battery including a positive electrode including a positive electrode active material; a lithium metal negative electrode; and the aforementioned molecular solid electrolyte.

The positive electrode active material may include at least one of lithium-cobalt-based oxide, lithium-nickel-based oxide, lithium-manganese-based oxide, lithium-nickel-cobalt-based oxide, lithium-nickel-manganese-based oxide, lithium-manganese-cobalt-based oxide, lithium-nickel-manganese-cobalt-based oxide, lithium-nickel-cobalt-aluminum oxide, and a lithium phosphate-based compound.

The positive electrode active material may be represented by Chemical Formula 6-1 or Chemical Formula 6-2.

LiₓM¹_{y}M²_{z}M³_{1-y-z}O_{2±a}X_{b} [Chemical Formula 6-1]

LiₓFePO₄ [Chemical Formula 6-2]

In Chemical Formula 6-1 and Chemical Formula 6-2,
0.5≤x≤1.8, 0≤a≤0.05, 0≤b≤0.05, 0<y≤1, 0≤z≤1, 0≤y+z≤1, M¹, M² and M³ are each independently one or more elements selected from a metal of Ni, Co, Mn, Al, B, Ba, Ca, Ce, Cr, Fe, Mo, Nb, Si, Sr, Mg, Ti, V, W, Zr, or La, and a combination thereof, and X is one or more elements selected from F, S, P or Cl.

The lithium metal battery can operate below a freezing point of the electrolyte solution.

The present invention enables ion transfer through an ion hopping mechanism by forming a lattice structure containing lithium transfer channels below the freezing point, and stabilizes a lithium metal interface by suppressing dendrite formation on the lithium metal surface.

In addition, the molecular solid electrolyte may be prepared from a combination of non-aqueous organic solvents and salts used in existing liquid electrolytes, so that it may be easily compatible with existing processes and the reforming and manufacturing processes are more economical.

### BRIEF DESCRIPTION OF THE DRAWINGS

FIG. 1 exhibits changes in discharge capacity according to temperature of lithium metal battery cells according to Comparative Example 1.

FIG. 2 exhibits changes in discharge capacity according to temperature of lithium metal battery cells according to Example 1.

FIG. 3 exhibits changes in discharge capacity according to temperature of lithium metal battery cells according to Example 2.

FIG. 4 exhibits changes in discharge capacity according to temperature of lithium metal battery cells according to Example 3.

FIG. 5 exhibits changes in discharge capacity according to temperature of lithium metal battery cells according to Example 4.

FIG. 6 is a graph showing changes in ionic conductivity according to the phase change section and temperature of the electrolyte solution.

FIG. 7 is a graph showing changes in lithium ion transference number according to the phase change section and temperature of the electrolyte solution.

FIG. 8 shows the discharge capacity change and coulombic efficiency of the lithium metal battery cells according to Example 3 and Comparative Example 2 at −30° C.

FIG. 9 is an SEM image of lithium electrodeposited after 20 cycles of a lithium metal battery cells according to Example 3 and Comparative Example 2 at −30° C.

FIG. 10 is a schematic view showing the measured distance between hopping sites within a non-aqueous organic solvent molecule.

### DETAILED DESCRIPTION OF THE EMBODIMENTS

Hereinafter, a rechargeable lithium battery according to an embodiment of the present invention will be described in detail with reference to the attached drawings. However, these embodiments are exemplary, the present invention is not limited thereto and the present invention is defined by the scope of claims.

As used herein, when a definition is not otherwise provided, “substituted” refers to replacement of at least one hydrogen of a substituent or a compound by deuterium, a halogen, a hydroxyl group, an amino group, a substituted or unsubstituted C1 to C30 amine group, a nitro group, a substituted or unsubstituted C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C20 alkoxy group, a C1 to C10 fluoroalkyl group, a cyano group, or a combination thereof.

In one example of the present invention, “substituted” refers to replacement of at least one hydrogen of a substituent or a compound by deuterium, a halogen, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. In addition, in specific examples of the present invention, “substituted” refers to replacement of at least one hydrogen of a substituent or a compound by deuterium, a halogen, a C1 to C20 alkyl group, a C6 to C30 aryl group, a C1 to C10 fluoroalkyl group, or a cyano group. In addition, in specific examples of the present invention, “substituted” refers to replacement of at least one hydrogen of a substituent or a compound by deuterium, a halogen, a C1 to C5 alkyl group, a C6 to C18 aryl group, a C1 to C5 fluoroalkyl group, or a cyano group. In addition, in specific examples of the present invention, “substituted” refers to replacement of at least one hydrogen of a substituent or a compound by deuterium, a cyano group, a halogen, a methyl group, an ethyl group, a propyl group, a butyl group, a phenyl group, a biphenyl group, a terphenyl group, a trifluoromethyl group, or a naphthyl group.

According to an embodiment of the present invention, a molecular solid electrolyte is formed from an electrolyte solution including a non-aqueous organic solvent, and a lithium salt, wherein the non-aqueous organic solvent is a single solvent, in the molecule, at least one central atom selected from a carbon atom, a nitrogen atom, a sulfur atom, and an atomic group consisting of these is contained, each of the central atoms are each independently linked to at least one oxygen atom; at least one sulfur atom; or at least one nitrogen atom, a maximum distance between two adjacent negatively charged atoms among the oxygen atom, sulfur atom, and nitrogen atom located at or linked to the central atom is less than or equal to about 5 A, and the electrolyte solution undergoes a phase change to a solid below a freezing point of the electrolyte solution to form a lattice structure including a lithium transfer channel.

The molecular solid electrolyte according to the present invention features that the electrolyte solution including the non-aqueous organic solvent of a single solvent undergoes a phase change to a solid below a freezing point of the electrolyte solution to form a lattice structure including a lithium transfer channel.

In order to form the lattice structure including the lithium transfer channel, the lithium transfer channel should be formed by locating hopping sites of the single solvent close one another within a significant distance, wherein the significant distance is, for example, about 2.0 Å to about 2.5 Å, which is a distance that oxygen atoms and lithium of the carbonate compound interact each other to continuously form the lithium transfer channel, and the hopping sites, assuming that the hopping sites are arranged in a row on both sides of lithium, are expected to have a maximum distance of about 5 Å or less

The hopping sites includes at least one central atom selected from a carbon atom, a nitrogen atom, a sulfur atom, and an atomic group consisting of these in a non-aqueous organic solvent molecule, wherein the central atom independently refers to an atom located at the central atom or an atom adjacently located to the oxygen atom, the sulfur atom, and the nitrogen atom connected to the central atom and having a negative partial charge in a molecule connected to at least one oxygen atom; at least one sulfur atom; or at least one nitrogen atom.

On the other hand, if a distance between the central atom and the oxygen atom, the sulfur atom, and the nitrogen atom connected thereto, that is, the distance between the hopping sites is beyond the above significant distance, the hopping sites are not located close together but spaced apart, making it difficult to form the lithium transfer channel through that lithium moves from one hopping site to another hopping site, and as a result, the electrolyte solution undergoes a phase change to a solid at a freezing point or less of the electrolyte solution, failing in forming the lattice structure including the lithium transfer channel.

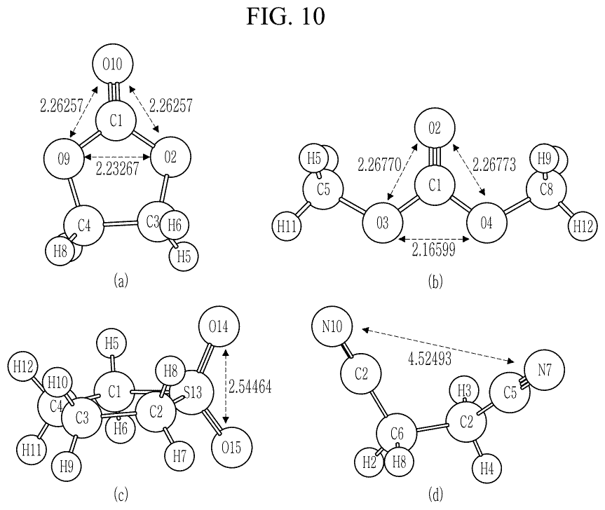

FIG. 10 is a schematic view showing the measured distance between hopping sites within a non-aqueous organic solvent molecule.

Referring to FIG. 10, because ethylene carbonate (EC, (a) of FIG. 10) and dimethyl carbonate (DMC, (b) of FIG. 10) among the carbonate compounds secure a distance between oxygen atoms in a range of about 2.17 to about 2.27 Å, which is the significant distance between the hopping sites, the lithium transfer channel may be expected to be formed.

In addition, because sulfolane (SL, (c) of FIG. 10) among the sulfone compounds secures the distance between oxygen atoms of about 2.54 Å, which is a significant distance between the hopping sites, the lithium transfer channel may be expected to be formed.

Furthermore, because succinonitrile (SCN, (d) of FIG. 10) secures about 4.52 Å of the significant distance between nitrogen atoms acting as the hopping sites, the lithium transfer channel may be expected to be formed.

In particular, when the atoms with negative partial charges within the significant distance capable of interacting lithium ions in a molecule, for example, oxygen atoms, sulfur atoms, and nitrogen atoms are located close, the lithium ions may smoothly hop, which may be more advantageous to form the lithium transfer channel.

From this point of view, the non-aqueous organic solvent is a single solvent, in the molecule, at least one central atom selected from a carbon atom, a nitrogen atom, a sulfur atom, and an atomic group consisting of these is contained, each of the central atoms are each independently linked to at least one oxygen atoms; at least one sulfur atom; or at least one nitrogen atom, and a maximum distance between two adjacent negatively charged atoms among the oxygen atom, sulfur atom, and nitrogen atom located at or linked to the central atom may be less than or equal to about 5 Å.

The non-aqueous organic solvent may be a compound including at least one of an acid anhydride functional group, an ester group, an amide group, a nitrile group, a nitrate group, a nitrite group, a nitro group, an imide group, an azide group, a sulfone group, a sulfonate group, a thiocyanate group, an isothiocyanate group, a carbonate group, a lactone group, a ketone group, and a thiol group.

The non-aqueous organic solvent may include an acid anhydride compound, an ester compound, an amide compound, a nitrate compound, a nitrite compound, a nitro compound, an imide compound, an azide compound, a sulfone compound, a sulfonate ester compound, a thiocyanate compound, an isothiocyanate compound, a carbonate compound, a lactone compound, a compound including at least two nitrile groups, a compound including at least two ketone groups, or a compound including at least two thiol groups.

For example, the non-aqueous organic solvent may be at least one of a sulfone compound, a carbonate compound, and a compound including at least two nitrile groups.

As a specific example, the sulfone compound is a cyclic sulfone compound and is represented by Chemical Formula 1, the carbonate compound is a cyclic carbonate compound or a linear carbonate compound and is represented by Chemical Formula 2 or Chemical Formula 3, the compound including at least two nitrile groups is a linear nitrile compound, and is represented by Chemical Formula 4.

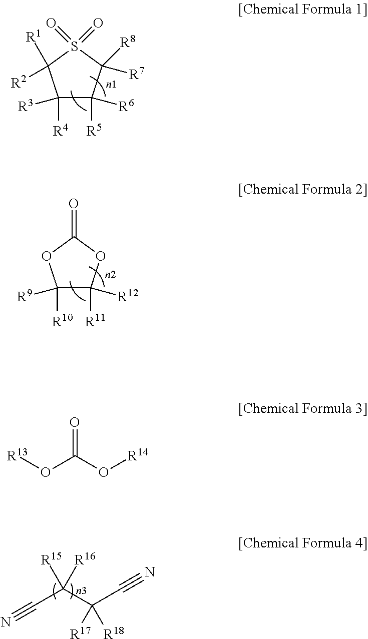

In Chemical Formula 1 to Chemical Formula 4,
R¹ to R¹⁴ are each independently hydrogen, a halogen, a substituted or unsubstituted C1 to C10 alkyl group, a substituted or unsubstituted C2 to C10 alkenyl group, or a substituted or unsubstituted C6 to C20 aryl group,
R¹⁵ to R¹⁸ are each independently hydrogen, a halogen, a cyano group, a substituted or unsubstituted C1 to C10 alkyl group, a substituted or unsubstituted C2 to C10 alkenyl group, or a substituted or unsubstituted C6 to C20 aryl group,
n1 and n2 are each independently an integer of 1 or 2, and
n3 is one of integers of 1 to 5.

As an example, R¹ to R⁸ in Chemical Formula 1 may each independently be hydrogen, a halogen, or a substituted or unsubstituted C1 to C5 alkyl group.

As an example, R⁹ to R¹⁴ in Chemical Formula 2 and Chemical Formula 3 may each independently be hydrogen, a halogen, or a substituted or unsubstituted C1 to C5 alkyl group.

As an example, R¹⁵ to R¹⁸ in Chemical Formula 4 may each independently be hydrogen, a halogen, a cyano group, or a substituted or unsubstituted C1 to C5 alkyl group.

For example, the cyclic sulfone compound represented by Chemical Formula 1 may be sulfolane.

For example, the cyclic carbonate compound represented by Chemical Formula 2 may be ethylene carbonate.

For example, the linear carbonate compound represented by Chemical Formula 3 may be dimethyl carbonate.

For example, the linear nitrile compound represented by Chemical Formula 4 may be succinonitrile.

The non-aqueous organic solvent may have a packing coefficient represented by Equation 1 of about 1 to about 1.1.

Packing coefficient=(Density in solid phase)/(Density in liquid phase). <Equation 1>

In a molecule, if the lithium transfer within the molecule is expressed by the aforementioned distance between sulfur, oxygen, and nitrogen atoms, a portion of the lithium transfer between the molecules may be explained through a packing coefficient. If the packing coefficient is within the range, because solid and liquid phases have no large density difference, the packing may be loose in the solid phase, which may contain a large amount of free volume and have an advantageous structure for forming an ion channel.

Among conventional solid electrolytes for lithium batteries, solid electrolytes such as sulfide series, oxide (LLZO) series, and the like are based on a covalent-net structure, in which atoms are mixed in a predetermined composition ratio and a lattice, but the molecular solid electrolyte according to the present invention is based on molecular unit crystals and formed in a similar form to ice.

In addition, the conventional solid electrolytes based on the covalent-net structure, whose manufacturing method and battery-manufacturing process are significantly different from those of conventional electrolytes based on liquid electrolytes, may not adopt the conventional liquid electrolyte-based system itself, but according to the present invention, because the molecular solid electrolyte based on molecule crystals uses a non-aqueous organic solvent and salt, etc., which are similar to the conventional liquid electrolyte-based system and interchangeable, the molecular solid electrolyte according to the present invention is economical in terms of modifying and manufacturing.

In general, if a phase change to a solid phase occurs, the lithium ion transfer may become difficult, mostly failing in operating a battery, but the present invention proposes a design of the molecular solid electrolyte capable of the lithium ion transfer and the battery operation despite the phase change of a liquid electrolyte to the solid phase at a freezing point or less. Accordingly, the present invention proposes a new type solid electrolyte preventing degradation/short circuit of lithium batteries and the resulting ignition.

Ionic conductivity for lithium ion batteries may be greater than or equal to about 1.0×10⁻³ mS cm⁻¹ at least. The molecular solid electrolyte according to the present invention may have ionic conductivity of greater than or equal to about 1.0×10⁻³ mS·cm⁻¹.

In addition, in order to operate batteries in a solid-phase electrolyte state, a lithium ion (Li⁺) transference number as well as the ionic conductivity should be considered, wherein a high lithium ion transference number may be evidence for ion channel formation.

In particular, if a lithium transfer channel is formed in a lattice structure, the lithium ion (Li⁺) transference number should be close to about 1.0.

The molecular solid electrolyte according to the present invention may have a lithium ion (Li⁺) transference number of about 0.6 to about 1.0.

Specifically, the lithium ion transference number may be about 0.7 to about 1.0, for example, about 0.8 to about 1.0.

The molecular solid electrolyte according to the present invention satisfies both conditions of the ionic conductivity and the lithium ion transference number within a predetermined temperature range of a freezing point or less.

The molecular solid electrolyte according to the present invention may have equivalent ionic conductivity to that of general solid electrolytes, for example, about 1.0×10⁻³ mS·cm⁻¹ to about 1.0×10⁻¹ mS·cm⁻¹.

The lithium salt may be at least one of LiPF₆, LiBF₄, LiSbF₆, LiAsF₆, LiC₄F₉SO₃, LiClO₄, LiAlO₂, LiAlCl₄, LiCl, LiI, LiB(C₂O₄)₂ (lithium bis(oxalato) borate; LiBOB), LiDFOB (lithium difluoro (oxalato) borate), and a bissulfonyl imide-based lithium salt.

For example, the lithium salt may be LiPF₆.

For example, the lithium salt may be LiDFOB.

For example, the lithium salt may be a bis-sulfonyl imide-based lithium salt.

As a specific example, the bissulfonyl imide-based lithium salt may be Li(FSO₂)₂N or LiN(CₓF₂ₓ₊₁SO₂)(C_{y}F_{2y+1}SO₂) (wherein x and y are integers from 1 to 20).

For example, the bissulfonyl imide-based lithium salt may be represented by any one of Chemical Formula 5A to Chemical Formula 5D.

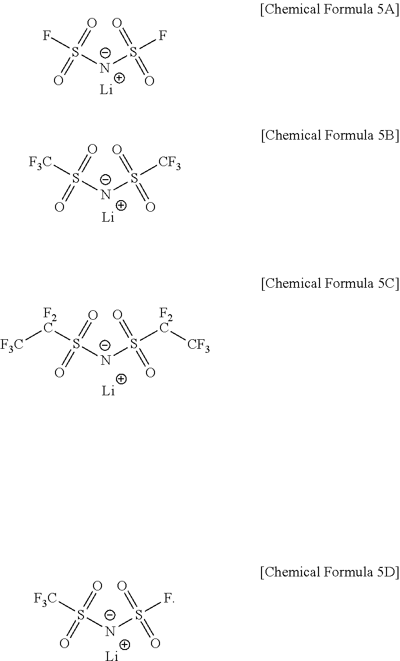

The lithium salt may have a concentration of about 0.1 m to about 4 m based on the electrolyte solution including the non-aqueous organic solvent and the lithium salt.

On the other hand, because the electrolyte solution has a different freezing point according to a concentration of the lithium salt, the concentration of the lithium salt may be adjusted to control the freezing point and thereby, a temperature range where the molecular solid electrolyte is operable. In an electrolyte solution at a high concentration of about 2 m or more, crystallization involving ions rather than a solvent-based lattice structure occurs to from molecular compounds, wherein anions serve as hopping sites, and when a distance between the anions satisfies a distance between the hopping sites, desired effects may be realized.

In other words, the freezing point may be adjusted according to a concentration of the lithium salt to operate the molecular solid.

Additionally, according to another embodiment of the present invention, a lithium metal battery includes a positive electrode including a positive electrode active material; a lithium metal negative electrode; and the aforementioned molecular solid electrolyte.

The positive electrode active material may include at least one of lithium-cobalt-based oxide, lithium-nickel-based oxide, lithium-manganese-based oxide, lithium-nickel-cobalt-based oxide, lithium-nickel-manganese-based oxide, lithium-manganese-cobalt-based oxide, lithium-nickel-manganese-cobalt-based oxide, lithium-nickel-cobalt-aluminum oxide, and a lithium phosphate-based compound.

More specific examples include compounds represented by any of the following chemical formulas.

LiₐA_{1-b}X_{b}D₂ (0.90≤a≤1.8, 0≤b≤0.5); LiₐA_{1-b}X_{b}O_{2-c}D_{c} (0.90≤a≤1.8, 0≤b≤0.5, 0≤c≤0.05); LiₐE_{1-b}X_{b}O_{2-c}D_{c} (0.90≤a≤1.8, 0≤b≤0.5, 0≤c≤0.05); LiₐE_{2-b}X_{b}O_{4-c}D_{c} (0.90≤a≤1.8, 0≤b≤0.5, 0≤c≤0.05); LiₐNi_{1-b-c}CO_{b}X_{c}Dₐ (0.90≤a≤1.8, 0≤b≤0.5, 0≤c≤0.5, 0<a≤2); LiₐNi_{1-b-c}Co_{b}X_{c}O₂₋ₐTₐ (0.90≤a≤1.8, 0≤b≤0.5, 0≤c≤0.05, 0<a<2); LiₐNi_{1-b-c}Co_{b}X_{c}O₂₋ₐT₂ (0.90≤a≤1.8, 0≤b≤0.5, 0≤c≤0.05, 0<a<2); LiₐNi_{1-b-c}Mn_{b}X_{c}Dₐ (0.90≤a≤1.8, 0≤b≤0.5, 0≤c≤0.05, 0<a≤2); LiₐNi_{1-b-c}Mn_{b}X_{c}O₂₋ₐTₐ (0.90≤a≤1.8, 0≤b≤0.5, 0≤c≤0.05, 0<a<2); LiₐNi_{1-b-c}Mn_{b}X_{c}O₂₋ₐT₂ (0.90≤a≤1.8, 0≤b≤0.5, 0≤c≤0.05, 0<a<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}Mn_{d}GₑO₂ (0.90≤a≤1.8, 0≤b≤0.9, 0≤c≤0.5, 0≤d≤0.5, 0.001≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂(PO₄)₃ (0≤f≤2); Li_{(3-f)}Fe₂(PO₄)₃(0≤f≤2); LiₐFePO₄ (0.90≤a≤1.8)

In the chemical formulas, A is selected from Ni, Co, Mn, and a combination thereof; X is selected from Al, Ni, Co, Mn, Cr, Fe, Mg, Sr, V, rare earth element, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

Of course, a compound having a coating layer on the surface may be used, or a mixture of the aforementioned compound and a compound having a coating layer can be used. This coating layer may include at least one coating element compound selected from an oxide of coating elements, a hydroxide of coating elements, an oxyhydroxide of coating elements, an oxycarbonate of coating elements and a hydroxycarbonates of coating elements. The compound that constitutes these coating layers may be amorphous or crystalline. The coating elements included in the coating layer may include Mg, Al, Co, K, Na, Ca, Si, Ti, V, Sn, Ge, Ga, B, As, Zr, or a mixture thereof. For the coating layer formation process, any coating method may be used as long as these elements can be used in the compound to coat the compound in a manner that does not adversely affect the physical properties of the positive electrode active material (e.g., spray coating, dipping method, etc.). Since this is well-understood by people working in the field, detailed explanation will be omitted.

For example, it may be LiCoO₂, LiNiO₂, LiMnO₂, LiMn₂O₄, Li(NiₐCO_{b}Mn_{c})O₂ (where, 0<a<1, 0<b<1, 0<c<1, a+b+c=1), LiNi_{1-Y}CO_{Y}O₂, LiCo_{1-Y}Mn_{Y}O₂, LiNi_{1-Y}Mn_{Y}O₂ (where, 0≤Y<1), Li(NiₐCo_{b}Mn_{c})O₄ (where, 0<a<2, 0<b<2, 0<c<2, a+b+c=2), LiMn_{2-z}Ni_{z}O₄, LiMn_{2-z}CO_{z}O₄ (where, 0<z<2), or LiₓFePO₄ (where, 0.5≤x≤1.8), but is not limited thereto.

In an embodiment, the positive electrode active material may be lithium iron phosphate (LiFePO₄), lithium cobalt oxide (LiCoO₂), lithium nickel manganese cobalt composite oxide (LiNiₓMn_{y}Co_{z}O₂), lithium nickel cobalt aluminum composite oxide (LiNi_{0.8}Co_{0.15}Al_{0.05}O₂).

The lithium metal battery can operate even below the freezing point of the electrolyte solution.

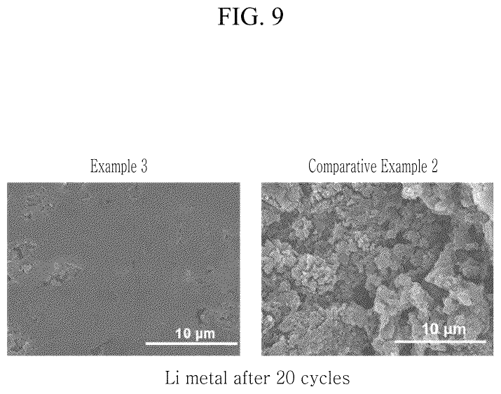

In addition, the lithium metal battery is effectively suppressed from lithium dendrite due to complex reasons such as a high lithium ion transference number at a freezing point or less of the electrolyte solution, suppression of solvent decomposition, and high mechanical strength due to the solid electrolyte, which are confirmed in FIG. 9.

The positive electrode and lithium metal negative electrode are manufactured and applied according to a conventional method known in the art.

The positive electrode may further include a current collector, and the current collector is not particularly limited, unless it has conductivity without causing chemical changes to the corresponding lithium metal batteries, for example, stainless steel, aluminum, nickel, titanium, calcined carbon, or aluminum or stainless steel that is surface-treated with carbon, nickel, titanium, silver, etc.

Hereinafter, examples and comparative examples of the present invention will be described. However, the following example is only an example of the present invention, and the present invention is not limited to the examples. Preparation of Electrolyte

### Example 1

An electrolyte solution was prepared to have the following composition, and a temperature thereof was decreased from 25° C. to −30° C. The electrolyte solution was phase-changed to a solid at a freezing point (about 21.6° C.) or less to prepare a molecular solid electrolyte.

### (Composition of Electrolyte Solution)

Lithium salt: 1 m of Lithium bis(trifluoromethanesulfonyl) imide (LiTFSI)

Non-aqueous organic solvent=ethylene carbonate

### Example 2

An electrolyte solution was prepared in the same manner as in Example 1 except that the non-aqueous organic solvent was changed to dimethyl carbonate.

The electrolyte solution was phase-changed to a solid at a freezing point (about −4° C.) or less to prepare a molecular solid electrolyte.

### Example 3

An electrolyte solution was prepared in the same manner as in Example 1 except that the non-aqueous organic solvent was changed to sulfolane.

The electrolyte solution was phase-changed to a solid at a freezing point (about −6.5° C.) or less to prepare a molecular solid electrolyte.

### Example 4

An electrolyte solution was prepared in the same manner as in Example 1 except that the non-aqueous organic solvent was changed to succinonitrile.

The electrolyte solution was phase-changed to a solid at a freezing point (about 23° C.) or less to prepare a molecular solid electrolyte.

### Comparative Example 1

An electrolyte solution was prepared by changing the composition as follows, and a temperature thereof was decreased from 25° C. to −30° C. The electrolyte solution was phase-changed to a solid at a freezing point (about −23° C.) or less to prepare a solid electrolyte.

### (Composition of Electrolyte Solution)

Lithium salt: 1 m of LiPF₆

Non-aqueous organic solvent=ethylene carbonate: dimethyl carbonate (3:7 v/v)

### Comparative Example 2

An electrolyte solution was prepared by changing the composition as follows, and a temperature thereof was decreased from 25° C. to −30° C.

Because there was no phase change within the temperature range, the electrolyte solution was formed into a liquid-phased electrolyte.

### (Composition of Electrolyte Solution)

Lithium salt: 1 m of LiPF₆

Non-aqueous organic solvent=ethylene carbonate: ethyl-methyl carbonate (3:7 v/v)

### Evaluation 1: Measurement of Ionic Conductivity

Ionic conductivity was measured based on EIS (Electrochemical Impedance Spectroscopy) analysis. The ionic conductivity was obtained by measuring impedance at an amplitude of 10 mV within a frequency range of 10⁻² Hz to 106 Hz at −40° C. to 25° C. and substituting the impedance into Equation 2.

$$σ = \frac{L}{RA} \qquad [ Equation 2 ]$$

(σ is ionic conductivity, L is a thickness of a pellet, R is impedance, and A an area of an electrode)

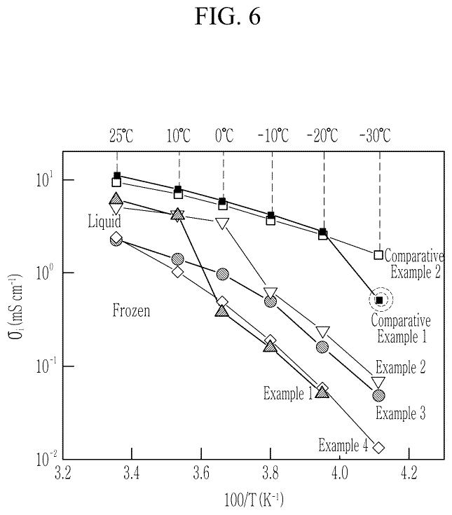

FIG. 6 is a graph showing changes in ionic conductivity according to the phase change section and temperature of the electrolyte solution.

Referring to FIG. 6, the electrolyte solutions according to Examples 1 to 4 were expected to maintain conductivity (10⁻¹ mScm⁻¹ to 10⁻³ mScm⁻¹) of a solid electrolyte after the phase change, enabling battery operation.

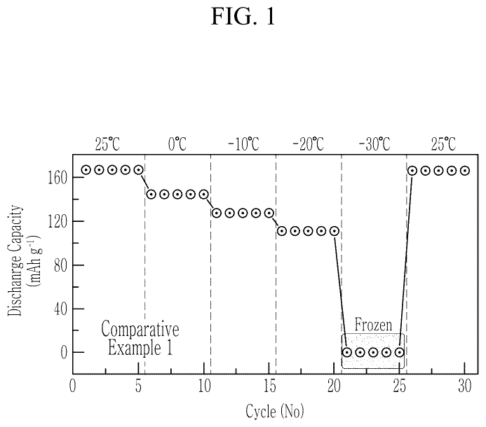

However, even though the electrolyte solution of Comparative Example 1 exhibited high ionic conductivity at a phase change point, the battery did not operate, as shown in FIG. 1. This is because a lithium ion transference number to be described later was not measured after the phase change, such a mixed solvent-based electrolyte solution as Comparative Example 1 has no smooth lithium ion conduction at −30° C. or less, when the mixed solvent-based electrolyte solution became solid, as is generally known.

In addition, the electrolyte solution of Comparative Example 2, as described above, had no phase change and thus was not formed into a solid electrolyte.

### Evaluation 2: Measurement of Lithium Ion Transference Number

The lithium ion transference number (t_{Li+}) was measured by using a potentiostatic polarization method. The lithium ion transference number (t_{Li+}) was calculated by measuring current density (I₀, I_{S}) and interface resistance (R₀, R_{S}) before and after the polarization through Equation 3.

$${t}_{Li +=} \frac{{I}_{s} ( Δ V - {I}_{0} {R}_{0} )}{{I}_{0} ( Δ V - {I}_{s} {R}_{s} )} \qquad [ Equation 3 ]$$

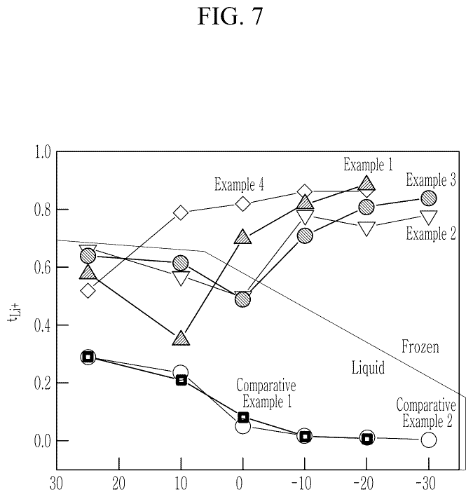

FIG. 7 is a graph showing changes in the lithium ion transference number according to the phase change section and temperature of the electrolyte solution.

Referring to FIG. 7, as described above, as a result of measuring the lithium ion transference number simultaneously indicating an ion conduction mechanism and lithium ionic conductivity, the electrolyte solutions of Examples 1 to 4 exhibited a significant increase in the lithium ion transference number after the phase change, but the lithium ion transference number of the electrolyte solution of Comparative Example 1 in the solid phase was not measured after the phase change.

Comparative Example 2, which was a liquid electrolyte with no phase change, exhibited a decrease in the lithium ion transference number according to a temperature decrease.

In the electrolyte solution of Comparative Example 1, in which a lattice structure including a lithium transfer channel in a solid state was not formed, the lithium ion transference number was expected to be not measured due to non-uniform ion conduction.

### Evaluation 3: Discharge Capacity Evaluation Depending on Temperature

Lithium iron phosphate (LiFePO₄) as a positive electrode active material, polyvinylidene fluoride as a binder, and acetylene black as a conductive material were mixed in a weight ratio of 80:10:10 and then, dispersed in N-methyl pyrrolidone to prepare positive electrode active material slurry.

The positive electrode active material slurry was coated to be 15 μm-thick Al foil, vacuum-dried at 110° C., and pressed, manufacturing a positive electrode.

Lithium metal was used as a negative electrode active material.

Positive and negative electrodes manufactured from the positive and negative electrode active materials were assembled with a separator made of a glass fiber material to manufacture an electrode assembly, and an electrolyte solution was injected thereinto, manufacturing a coin half-cell.

The cells (battery capacity: 0.25 mAh) manufactured by respectively using the electrolyte solutions according to Examples 1 to 4 and Comparative Example 1 were charged to a constant current of 4.0 V at a rate of 0.2 C at various temperatures (25° C. to −30° C.).

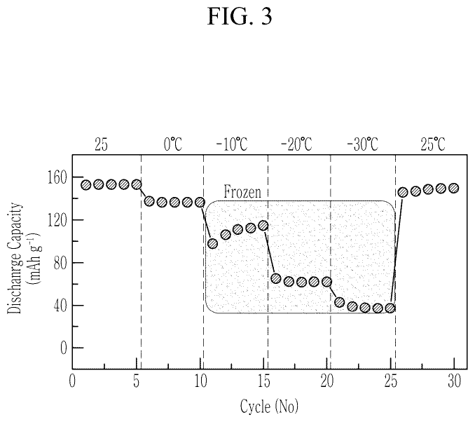

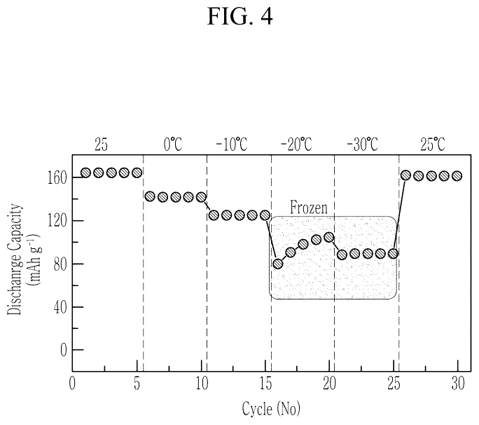

Subsequently, the cells were discharged to 2.8 V at a constant current rate of 0.2 C. The charge and discharge were 5 cycles repeated to measure capacity by changing temperatures, and the results are shown in FIGS. 1 to 5.

FIGS. 1 to 5 show discharge capacity changes of the lithium metal battery cells of Comparative Example 1 and Examples 1 to 4 according to a temperature.

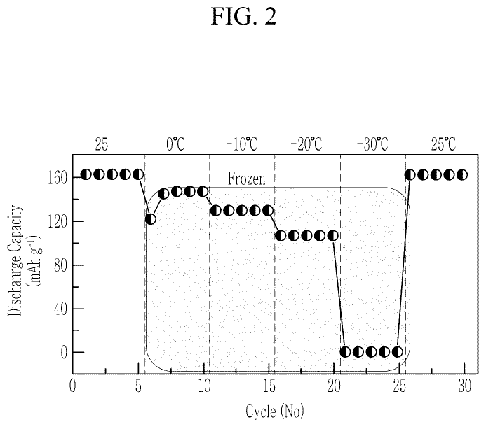

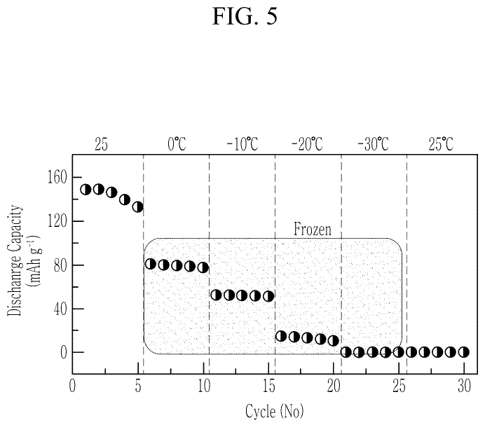

Referring to FIG. 1, Comparative Example 1, in which a mixed solvent-based electrolyte solution was included, did not operate at a freezing point of the electrolyte solution or less (discharge capacity of 0), but referring to FIGS. 2 and 5, Examples 1 to 4, in which a single solvent-based electrolyte solution with an advantageous molecule structure for forming a lithium transfer channel was included, operated even after the phase change to a solid-phase state at a freezing point or less of the electrolyte solution.

### Evaluation 4: Electrochemical Performance Evaluation of Organic Ice Electrolyte

Coulombic efficiency (hereinafter, “CE”) was defined as charging (Li stripping) capacity to discharging (Li plating) capacity.

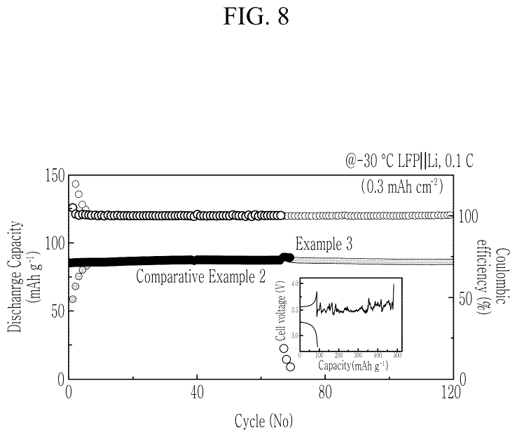

The lithium metal battery cells manufactured in the same manner as in Evaluation 1 were measured with respect to coulombic efficiency and discharge capacity at −30° C., and the results are shown in FIG. 8.

FIG. 8 shows discharge capacity changes and coulombic efficiency of the lithium metal battery cells of Example 3 and Comparative Example 2.

Referring to FIG. 8, Example 3 of a solid-phase electrolyte at −30° C. realized excellent cycle-life characteristics without capacity reduction. On the contrary, Comparative Example 2 of a liquid electrolyte at the corresponding temperature exhibited deteriorated cycle-life characteristics by a soft short due to growth of lithium dendrite.

### Evaluation 5: Morphological Analysis of Electrodeposited Lithium

The lithium metal battery cells manufactured in the same manner as in Evaluation 3 were 20 cycles operated at −30° C. to analyze an SEM image, and the results are shown in FIG. 9.

FIG. 9 is an SEM image of electrodeposited lithium after the 20 cycles of the lithium metal battery cells of Example 3 and Comparative Example 2 at −30° C.

Referring to FIG. 9, unlike the liquid electrolyte of Comparative Example 2, of which the surface had lots of pores due to considerable growth of dendrite after the 20 cycles, the solid-phase electrolyte of Example 3 turned out to have a relatively smooth surface without pores.

Although the preferred embodiments of the present invention have been described through the above, the present invention is not limited thereto, and can be implemented by various modifications within the scope of the claims and detailed description of the invention and the accompanying drawings, which also fall within the scope of the present invention.

What is claimed is:

1. A molecular solid electrolyte formed from an electrolyte solution comprising
a non-aqueous organic solvent, and
a lithium salt,
wherein the non-aqueous organic solvent is a single solvent,
in the molecule, at least one central atom selected from a carbon atom, a nitrogen atom, a sulfur atom, and an atomic group consisting of these is contained,
each of the central atoms are each independently linked to at least one oxygen atom; at least one sulfur atom; or at least one nitrogen atom,
a maximum distance between two adjacent negatively charged atoms among the oxygen atom, sulfur atom, and nitrogen atom located at or linked to the central atom is less than or equal to about 5 Å, and
the electrolyte solution undergoes a phase change to a solid below a freezing point of the electrolyte solution to form a lattice structure including a lithium transfer channel.

2. The molecular solid electrolyte of claim 1, wherein
the non-aqueous organic solvent is a compound including at least one of an acid anhydride functional group, an ester group, an amide group, a nitrile group, a nitrate group, a nitrite group, a nitro group, an imide group, an azide group, a sulfone group, a sulfonate group, a thiocyanate group, an isothiocyanate group, a carbonate group, a lactone group, a ketone group, and a thiol group.

3. The molecular solid electrolyte of claim 1, wherein
the non-aqueous organic solvent includes an acid anhydride compound, an ester compound, an amide compound, a nitrate compound, a nitrite compound, a nitro compound, an imide compound, an azide compound, a sulfone compound, a sulfonate ester compound, a thiocyanate compound, an isothiocyanate compound, a carbonate compound, a lactone compound, a compound including at least two nitrile groups, a compound including at least two ketone groups, or a compound including at least two thiol groups.

4. The molecular solid electrolyte of claim 3, wherein
the non-aqueous organic solvent is at least one of a sulfone compound, a carbonate compound, and a compound including at least two nitrile groups.

5. The molecular solid electrolyte of claim 4, wherein
the sulfone compound is a cyclic sulfone compound and is represented by Chemical Formula 1,
the carbonate compound is a cyclic carbonate compound or a linear carbonate compound and is represented by Chemical Formula 2 or Chemical Formula 3, and
the compound including at least two nitrile groups is a linear nitrile compound, and is represented by Chemical Formula 4: 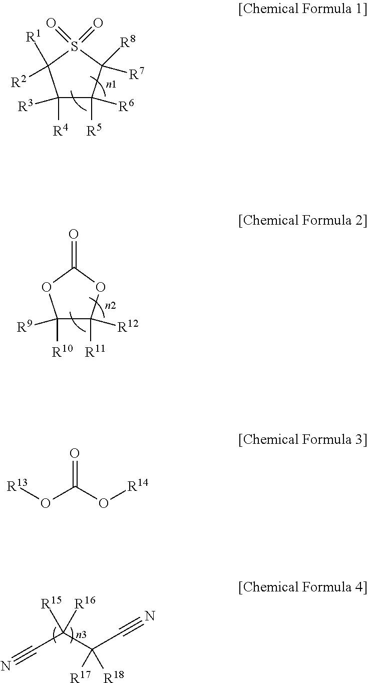
wherein, in Chemical Formula 1 to Chemical Formula 4,
R¹ to R¹⁴ are each independently hydrogen, a halogen, a substituted or unsubstituted C1 to C10 alkyl group, a substituted or unsubstituted C2 to C10 alkenyl group, or a substituted or unsubstituted C6 to C20 aryl group,
R¹⁵ to R¹⁸ are each independently hydrogen, a halogen, a cyano group, a substituted or unsubstituted C1 to C10 alkyl group, a substituted or unsubstituted C2 to C10 alkenyl group, or a substituted or unsubstituted C6 to C20 aryl group,
n1 and n2 are each independently an integer of 1 or 2, and
n3 is one of integers of 1 to 5.

6. The molecular solid electrolyte of claim 1, wherein
the non-aqueous organic solvent has a packing coefficient represented by Equation 1 of about 1 to about 1.1:
Packing coefficient=(Density in solid phase)/(Density in liquid phase) <Equation 1>
.

7. The molecular solid electrolyte of claim 1, wherein
ionic conductivity is greater than or equal to about 1.0×10⁻³ mS cm⁻¹, and
lithium ion transference number (Li⁺ transference number) is about 0.6 to about 1.0.

8. The molecular solid electrolyte of claim 1, wherein
the lithium salt is at least one of LiPF₆, LiBF₄, LiSbF₆, LiAsF₆, LiC₄F₉SO₃, LiClO₄, LiAlO₂, LiAlCl₄, LiCl, LiI, LiB(C₂O₄)₂ (lithium bis(oxalato) borate; LiBOB), LiDFOB (lithium difluoro(oxalato)borate), and a bissulfonyl imide-based lithium salt.

9. The molecular solid electrolyte of claim 8, wherein
the bissulfonyl imide-based lithium salt is Li(FSO₂)₂N or LiN(CₓF₂ₓ₊₁SO₂) (C_{y}F_{2y+1}SO₂), wherein x and y are an integer of 1 to 20.

10. The molecular solid electrolyte of claim 8, wherein
the bissulfonyl imide-based lithium salt is represented by any one of Chemical Formula 5A to Chemical Formula 5D:

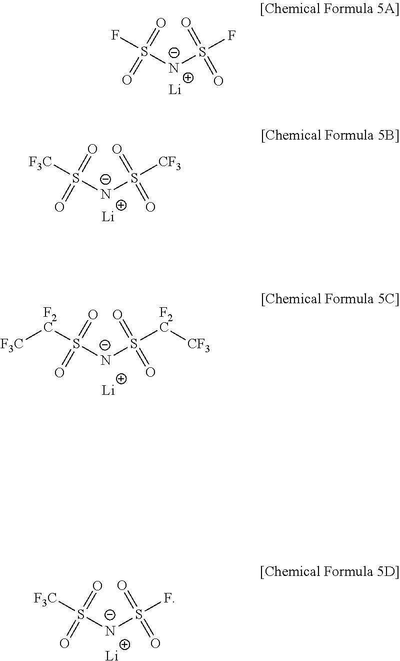

11. A lithium metal battery, comprising
a positive electrode including a positive electrode active material;
a lithium metal negative electrode; and
the molecular solid electrolyte of claim 1.

12. The lithium metal battery of claim 11, wherein
the positive electrode active material includes at least one of lithium-cobalt-based oxide, lithium-nickel-based oxide, lithium-manganese-based oxide, lithium-nickel-cobalt-based oxide, lithium-nickel-manganese-based oxide, lithium-manganese-cobalt-based oxide, lithium-nickel-manganese-cobalt-based oxide, lithium-nickel-cobalt-aluminum oxide, and a lithium phosphate-based compound.

13. The lithium metal battery of claim 11, wherein
the positive electrode active material is represented by Chemical Formula 6-1 or Chemical Formula 6-2:
LiₓM¹_{y}M²_{z}M³_{1-y-z}O_{2±a}X_{b} [Chemical Formula 6-1]
LiₓFePO₄ [Chemical Formula 6-2]
wherein, in Chemical Formula 6-1 and Chemical Formula 6-2,
0.5≤x≤1.8, 0≤a≤0.05, 0<b≤0.05, 0<y≤1, 0≤z≤1, 0≤y+z≤1, M₁, M₂ and M³ are each independently one or more elements selected from a metal of Ni, Co, Mn, Al, B, Ba, Ca, Ce, Cr, Fe, Mo, Nb, Si, Sr, Mg, Ti, V, W, Zr, or La, and a combination thereof, and X is one or more elements selected from F, S, P or Cl.

14. The lithium metal battery of claim 11, wherein
the lithium metal battery operates even below the freezing point of the electrolyte solution.
